(19) United States
(12) Patent Application Publication
(10) Pub. No.: US 2003/0020618 A1
(43) Pub. Date: Jan. 30, 2003

(54) Methamphetamine and other illegal drug manufacture detector

(76) Inventors: Randy Hemmer, Boise, ID (US); Ron Wilson, Boise, ID (US)

Correspondence Address: PEDERSEN & COMPANY, PLLC, P.O. BOX 2666, BOISE, ID, 83701, US

(21) Appl. No.: 10/127,162

(22) Filed: Apr. 15, 2002

Related U.S. Application Data
(60) Provisional application No. 60/283,595, filed on Apr. 13, 2001.
(60) Provisional application No. 60/316,309, filed on Aug. 29, 2001.

(51) Int. Cl. G08B 17/10

(52) U.S. Cl. 340/632; 340/539

(57) ABSTRACT

The invention is a system for detecting air conditions in a residential room, apartment, or other building that suggest the manufacture of illicit drugs or other illegal substances, such as methamphetamine. The invention includes a compact sensor that may be secretly installed in a room to sense levels of VOC's and/or other solvents and/or other hazardous chemicals in the ambient air of the room that are indicative of illegal drug or chemical manufacture. Upon sensing an event at or above the pre-determined alarm level, the sensor system signals an alarm, preferably a wireless, hard-wired, or other electric or electronic signal to a remote location, such as a building manager's office, a police station, or other community authority. The invention comprises a gas or vapor sensor adjusted or set to detect levels of VOC's and/or solvents and/or other hazardous chemicals in air, at the 100-900 ppm range, instead of the parts per hundred (pph) or low parts per million (ppm) (less than 100 ppm) or parts per billion (ppb) range that are typically available in prior art gas or vapor sensors.

### DESCRIPTION

This application claims priority of our prior provisional patent applications, Serial No. 60/283,595, filed on Apr. 13, 2001, entitled “Methamphetamine Manufacture Detector,” and Serial No. 60/316,309, filed on Aug. 29, 2001, entitled “Methamphetamine Manufacture Detector (II),” which are both incorporated herein by reference.

### BACKGROUND OF THE INVENTION

1. Field of the Invention

This invention relates generally to chemical sensors and detectors. More specifically, this invention relates to gas or vapor detectors for volatile organic compounds (VOC's) and/or solvents and/or other hazardous chemicals used in the illegal manufacture of methamphetamine (“meth”) and other illicit drugs, including but not limited to Ecstasy and PCP.

2. Related Art

“Meth,” the street name for the stimulant methamphetamine, has become a major illicit drug problem. Other illicit drugs like “ecstasy” are also growing drug problems. Community leaders and law enforcement officials are looking for assistance with these drug problems. One proposed solution strategy is to minimize the availability of these drugs by minimizing their production. This approach, however, has been frustrated by the ease of their production, and the ease of portability of the facilities for their production.

Typically, production of “meth” and other illicit drugs includes extraction, with a solvent, of the active ingredients from a precursor material. Then, typically, the solvent containing the extract is volatilized, usually by heating, until the solvent is totally vaporized and leaves behind a solid residue that is a rough form of the street drug. This volatilization and evaporation step results in large amounts of VOC's and/or solvents entering the air around the site of manufacture of these illicit drugs. These solvents typically include acetone, gasoline, anhydrous ammonia, stove fuel (Coleman™), and others.

Therefore, the inventors believe that a promising strategy for “meth” manufacture control is to sense and detect the high level of VOC's and/or solvents in the air around the site of manufacture of the illicit drugs. This invention uses such a strategy.

### SUMMARY OF THE INVENTION

The invention comprises a system for detecting air conditions in a room or other space that suggest the manufacture of illicit drugs or other illegal substances, such as methamphetamine. The invention preferably comprises a compact sensor that may be either discretely or overtly installed in a room, which sensor efficiently senses levels of VOC's and/or other solvents in the ambient air of the room that are indicative of illegal manufacture, and that alarms or otherwise signals preferably a remote location, such as a building manager's office, a police station, or other community authority. Preferably, there is no audible sound produced by the invented remote sensor system in the room being monitored, but, rather, only a signal to an appropriate location(s) to warn of illegal manufacture in the room. The design may also include a version that has an audible alarm for applications where remote sensing is impractical or economically infeasible.

The invention comprises a gas or vapor sensor adjusted or set to detect levels of VOC's and/or solvents and/or other hazardous chemicals in air that are typical for illicit drug manufacture. Preferably, the sensor is set during manufacture or adjusted after manufacture to detect a concentration of a chemical or group of chemicals in the ambient room air that is outside the target range of detection for conventional sensors for conventional purposes, such as measurements of explosive limits, or toxic exposure from such materials as hydrogen sulfide and carbon monoxide.

For example, some embodiments of the invented system would be adjusted or built to sense an event in the range of parts per million (ppm) of the chemical/chemical group of interest in the room ambient air, instead of the much higher parts per thousand (ppt) range that is typical for explosive limit meters. This way, when an event is sensed that is above the “event detection threshold” that is a ppm value pre-set/adjusted within the preferred range, the invented device triggers an alarm. Preferably, the event detection threshold is set at a level in the range of about 100-900 ppm concentration of the compound(s) in the air being sensed. An explosive limit meter, on the other hand, is conventionally designed for detecting from the parts per hundred (pph) range down to the lower parts per thousand (ppt) range (or, at lowest, down to the upper parts per million range, that is, >900 ppm). A typical explosive limit meter alarms at 10-20% of the lower explosive limit (LEL) which would be 1.2-2.4 ppt (1200-2400 ppm) for gasoline, for example.

The preferred 100-900 ppm detection range of the preferred embodiments of the invented device is significantly different from the detection range of typical toxic gas or vapor exposure monitors, which is the low parts per million (<100 ppm and usually less than about 50 ppm) down to parts per billion (ppb). Such toxic exposure monitors, which are designed to detect hydrogen sulfide (H₂S) or carbon monoxide (CO) for example, typically alarm at about 10 ppm for hydrogen sulfide (H2S) and about 35 ppm for carbon monoxide (CO).

The preferred 100-900 ppm range of the present invention, then, is between the ranges for sensors for explosive limit and for toxic exposure. This 100-900 ppm detection threshold is a particularly effective method for detecting the levels of VOC's/solvents in the room air that are produced around illicit drug manufacture. Setting such detection ranges in the invented device tend to prevent the device from alarming due to the presence of legal products and legal activities in the household or office, and yet are sensitive enough to detect the chemical concentrations that result in the typical apartment, home, or storage building setting where batches of illegal drugs are produced. The individuals producing the batches tolerate concentrations in the 100-900 ppm range in the air they are breathing, and so tend to conduct the manufacture in generally poorly-ventilated environments that produce such a range. The invented device is not so sensitive that it should trigger false alarms, but is sensitive enough to trigger an alarm in most of the illegal drug manufacture environments scattered in some neighborhoods of our cities and towns.

Therefore, Applicants' invention is particularly well-adapted for residential spaces, which are a typical locations for conventional industrial sensors that are designed for explosive limits or toxic exposure sensors. The residential spaces contemplated by Applicants are homes, apartments, garages and other residential outbuildings, motel and hotel rooms and vehicles.

### BRIEF DESCRIPTION OF THE DRAWINGS

FIG. 1 is an electrical schematic drawing of one embodiment of a sensor section of this invention.

FIG. 2 is an electrical schematic drawing of one alarm latching circuit, coupled with a time delay and a transmitter for operative connection and cooperation with the sensor section of this invention.

FIG. 3A is a schematic drawing of one application of embodiments of the invention, wherein an embodiment of the invented device is hidden in an apartment and adapted to communicate with a remote receiver unit at a landlord's office.

FIG. 3B is a schematic drawing of another application of embodiments of the invention, wherein another embodiment of the invented device is installed in view in a rented storage building and adapted to communicate with a remote receiver unit at a security or police officer's office.

FIG. 4 is a diagram of the preferred embodiment's range for chemical detection, compared to those for conventional explosive limit monitors and toxic exposure monitors.

FIG. 5 is a schematic electrical diagram of an especially-preferred embodiment of the sensor section of this invention.

FIG. 6 is an electrical schematic drawing of one alarm latching/transmitting circuit of an especially-preferred embodiment, coupled with a time delay and a transmitter for operative connection and cooperation with the sensor system of FIG. 5.

### DETAILED DESCRIPTION OF THE PREFERRED EMBODIMENTS

Referring to the drawings, there are shown schematics and drawings that illustrate some, but not the only, embodiments of the invented sensor system for illicit drug manufacture. The invention comprises a device 10 to detect the presence of solvents, VOC's and/or other industrial chemicals 20 used in the manufacture of illegal drugs in a non-industrial environment. For the purpose of this description, a non-industrial environment includes, but is not limited to, residential living areas, such as houses, apartments, garages or other storage areas, hotel/motel rooms and storage areas, storage garages, warehouses, or other areas available for rent to the public, and automobiles, vans, RV's, etc. Typically these are smaller buildings or individual rooms in larger buildings, that are generally available for rent or other short term usage. Drug manufacture operations are set up inexpensively for quick production without investment in ventilation or other industrial-quality equipment. The fumes from drug manufacture, as discussed above, permeate the room/spaces during the manufacture, and sometimes are noticeable to passers-by or neighbors. Because of the often-temporary nature of these operations, and because of neighbors concern about getting involved, it is difficult for law enforcement, landlords, or property managers to know, and to have evidence of, when the manufacturing is taking place. The present invention addresses the need for improvement in monitoring and alarming when such activity is taking place.

The preferred sensor system 10 triggers an alarm upon exposure to the presence of solvents, VOC's and/or other industrial chemicals 20. This alarm signal 30 is adapted to warn the authorities or other concerned parties of the presence of industrial-type solvents and, therefore, the probability of illegal activity in the room or space 40 being monitored, that is, the probability of manufacture/refinement of controlled substances 50. The device 10 preferably comprises a local unit 12 in the room being monitored, and a remote receiver unit 14 for receiving the alarm signal and making it known to the individual(s) authorized to have access to that information.

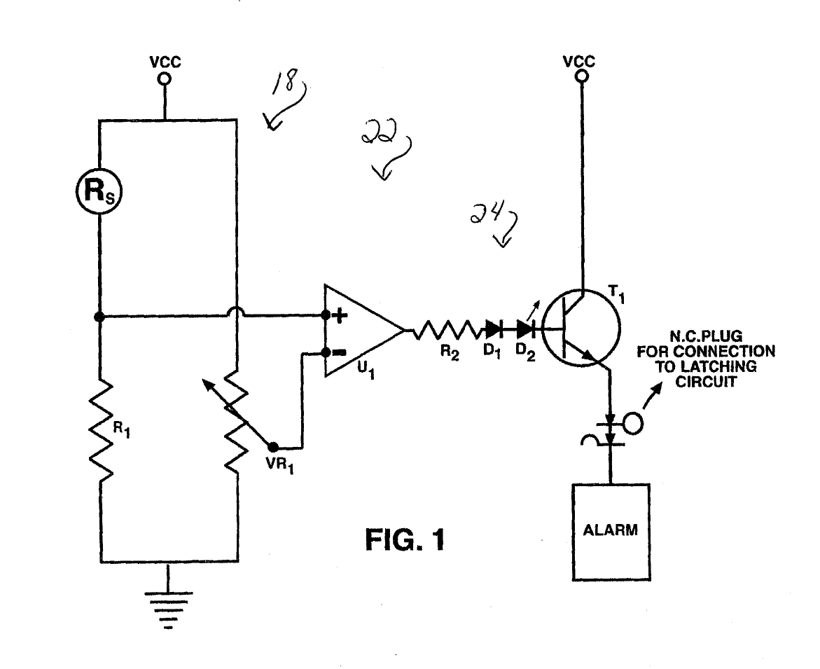

FIG. 1 illustrates one embodiment of the electronics of the local unit 12. The primary sensor 16 of the local unit 12 of the preferred embodiment of the invention may be described as follows:

The preferred primary sensor is manufactured using thick film techniques whereby the sensor material, typically tin oxide, is printed on a substrate. The substrate is heated to a predetermined level. The temperature of the heating element remains constant, and, therefore, the resistivity of the sensor material remains constant. If a flammable solvent is present, it will bond to the sensor material, resulting in lower resistance, which can be measured. Upon detection of a solvent, VOC, or other industrial chemical preferably in this manner, an alarm is activated at a remote location to signal and notify the concerned party, while preferably no sound or other noticeable signal is emitted in the room being monitored. Sensor material on a substrate that may be utilized in embodiments of the invention is available from, for example, Figaro Sensors (Japan) and from International Sensor Technology, Inc. (USA). Such sensor material is described, for example, in Hazardous Gas Monitors by Jack Chou (McGraw Hill, 2000). Further, a secondary sensor (not shown) particularly adapted for specific chemical(s) may be employed in order to detect the presence of those specific chemicals of particular interest to the authorities or other concerned parties.

The measuring circuit, in the preferred embodiment of FIG. 1, comprises a wheat-stone bridge 18 which comprises the sensor, a fixed value resistor, and a variable resistor. The outputs of the wheat-stone bridge are connected to a comparator circuit 22. When a chemical is present, the resistivity of the sensor decreases, thereby increasing the voltage relative to the voltage on the fixed voltage divider of “leg B” of the wheat-stone bridge. The increased voltage on “leg A” causes the comparator to give a “high” output.

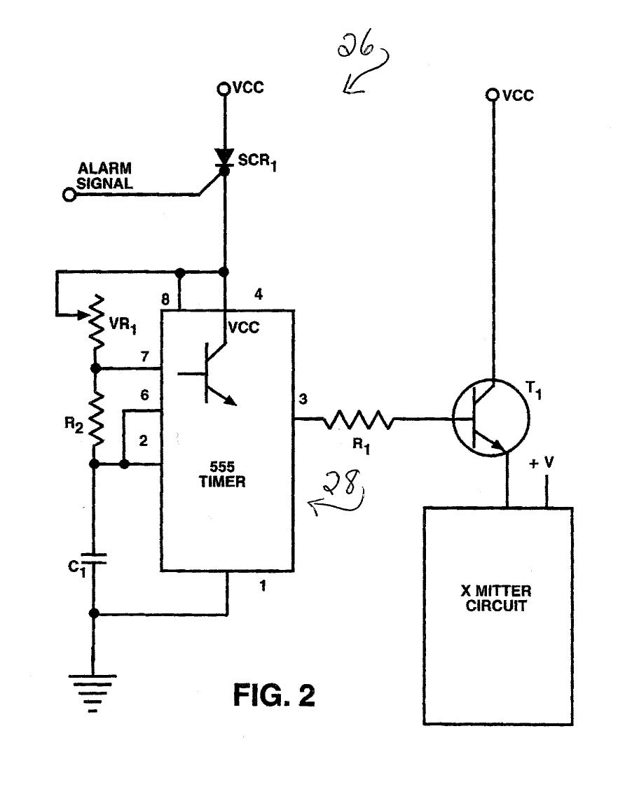

The output of the comparator in FIG. 1 is transistor-buffered (24) to switch on a latching circuit, illustrated in the embodiment of FIG. 2. The latching circuit 26 may be composed of either a latching relay or an SCR. The latching circuit is used to drive a transmitter, either wired or wireless, which notifies the responsible party that industrial chemicals are present within the area, thus, indicating a high probability that the manufacture of illegal and/or controlled substances has/is taking place in the environment of the sensor.

Further Referring to FIGS. 1 and 2:

Note that, in the preferred embodiment of FIGS. 1 and 2, the VOC sensor changes resistance in the presence of VOCs and other solvents. The wheat-stone bridge supplies the reference voltages. The comparator is triggered to an “on” position when the reference voltage on the sensor side is higher than the adjustable reference voltage. The transistor acts as a buffer between the comparator stage and the alarm stage. The diodes prevent an offset drift voltage from sounding a false alarm. Preferably, the local unit detection threshold adjustor is accessible after manufacture of the local unit, so that the landlord or other authorities may adjust the event detection threshold to one that is appropriate for the room or for the particular VOC or solvent being used in the suspected chemical or drug manufacture. Calibration information may be supplied by the manufacturer of the local unit, or may be established/fine-tuned by experimentation in the room before renting out of the space.

The symbols in FIG. 1 may be described as follows: Rs (sensor); R₁ (reference resistor); VR₁ (offset adjust-calibration); U₁ (comparator); R₂ (current limiting resistor); D₁ (bias diode, reduces false alarms); D₂ (LED for visual aid in adjusting VR₁); T1 (driver transistor, powers the alarm circuit). Therefore, moving left to right in FIG. 1, one may describe the circuit as having a detector section, a comparator section, and a driver section.

Other, conventional sensors besides the wheat-stone bridge device disclosed herein may be substituted for the subject sensor. For example, an infrared spectrometer may be used to detect and identify particles of substances used in the manufacture of illicit drugs and/or the illicit drugs themselves.

A unique feature of the invention is the combination of a residential space and a sensor for VOC's and/or solvents and/or other hazardous chemicals adjusted or set to detect and alarm at between about 100-900 ppm, most preferably about 450-650 ppm, and less preferably 200-800 ppm. Also unique is the invented method of detecting the illicit manufacture of “meth” and other drugs with this type of sensor. The preferred local unit 12 including the sensor 16 is installed in a wall 32, ceiling, cabinetry, or other structure or location, preferably in the interior of the room, to which the room air circulates in a manner that would produce accurate readings. Preferably, the local unit 12 is disguised or hidden so that the occupants of the room are unaware of the device.

Also, additional, optional equipment may be combined with the subject sensor. For example, an intake fan or vacuum system (not shown) may be added to increase sensitively and/or accuracy. Also, the sensor may be combined to work with a smoke or a CO detector. Also, the sensor may be disguised to look like conventional equipment 34 or included in a housing with conventional equipment, such as a wall outlet or phone jack, to avoid detection and disablement of the sensor system.

Also, the inventive sensor and local unit 12 may be combined with other helpful features, besides the alarm feature. For example, the sensor may be operably coupled with time-stamp, log and reporting features to provide the authorities with a history of the air conditions in the residence—that is, to record recurring events of suspected drug manufacture in the residence. Also, the sensor may be operably coupled with communications features, both short and/or long range, radio and/or hard-wired. Also, the sensor may be operably coupled with screening features to eliminate or minimize false alarms and interference. For example, the sensor may be coupled with a timing circuit 28, as shown in FIG. 2. A timing circuit may require a certain period of time of sensing above the pre-determined limit before the alarm is latched on. For example, if the pe-determined limit is set at 400 ppm (a particular value within the preferred range of 100-900 ppm), and the industrial chemical is sensed at above 400 ppm for more than the time delay period, then the alarm will be signaled. Or, the system may be designed so that, for example, 3 alarm “events” within a predetermined amount of time, for example, 5 minutes, in order to “latch-on” the alarm.

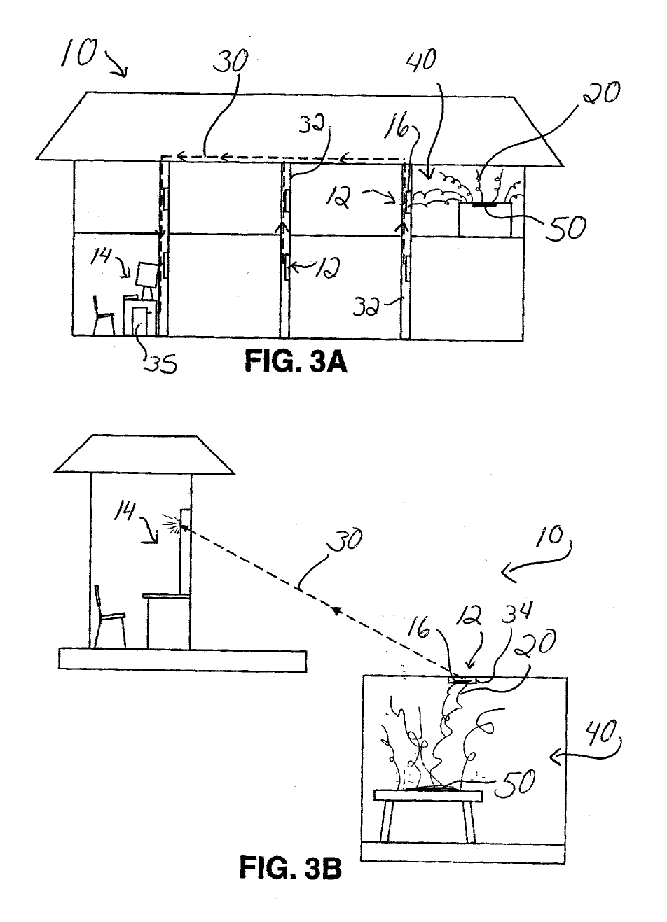

FIG. 3A illustrates one of many uses for embodiments of the invented system. In FIG. 3A, an illegal drug is being manufactured in an apartment that, like the others in the building, contain a local unit 12 according to the invention hidden behind a vent or other gas-permeable structure in a wall. The local unit 12 detects VOCs and other solvents, and has been pre-set with an event detection threshold value of 200 ppm, for example. The fumes from solvent evaporation circulate around the room, reaching the sensor, and, when they reach 200 ppm at the sensor, the sensor signals an alarm via a hard-wired connection to a remote station 14 in the property manager's office. Preferably, the local unit does not produce any locally-audible or other locally-perceptible alarm, so that the individuals conducting the drug manufacture are not alerted to being detected. The remote station 14 may be adapted for an alarm signal (audible, visible, or both) on a computer system 35 or other monitor. Preferably, the property manager may look up the alarm information, such as time, duration, location, and/or other information which the sensor and local unit are adapted to collect and send. Optionally, the remote station 14 may include a print-out system or other memory and storage for recording and proving that such events have happened.

In FIG. 3B, the local unit 12 is visible on the ceiling of the storage unit, or is inside a fire-detector-appearing unit 34 that is visible on the ceiling. In this case, the sensor has been preset with an event detection threshold of 550 ppm, for example. When vaporizing chemicals from drug manufacture or other solvents or VOC's reach 550 ppm in the air reaching the local unit 12, the local unit 12 sends a wireless signal to a remote receiver unit 14 at a guard house or storage facility security office. Preferably, the local unit does not produce any locally-audible or other locally-perceptible alarm, so that the individuals conducting the drug manufacture are not alerted to being detected.

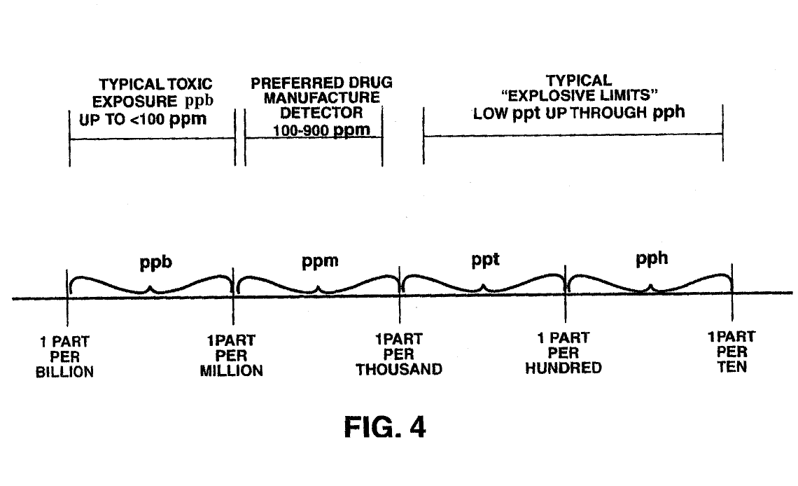

FIG. 4 illustrates the preferred detection range of embodiments of the invention, compared to conventional explosive limit or toxic exposure detectors.

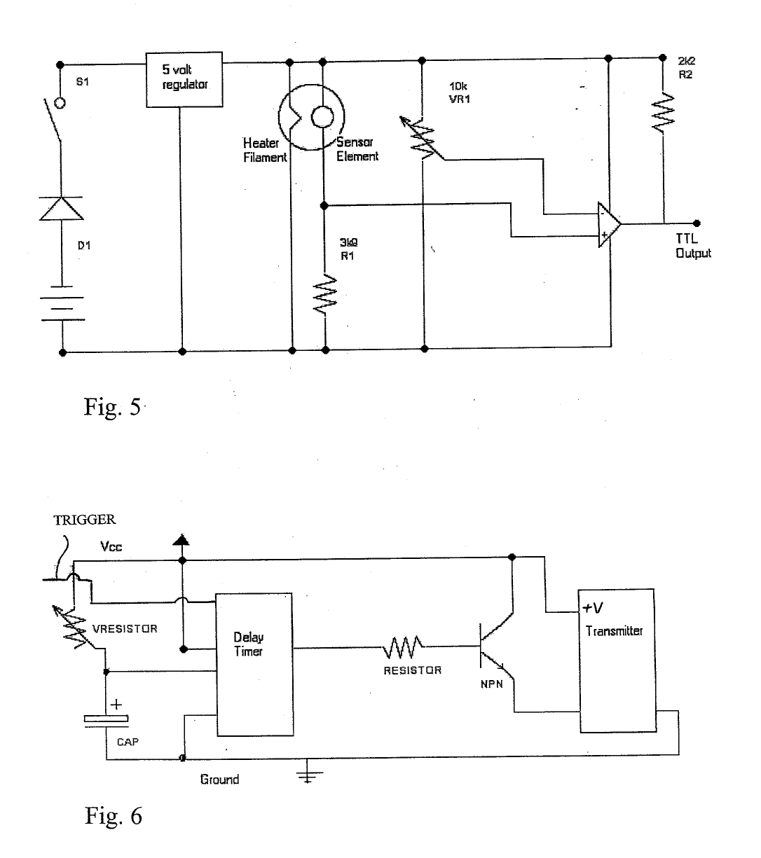

FIGS. 5 and 6 illustrate alternative, especially-preferred embodiments of sensor and transmission portions of a local unit. The functionality of the circuits in FIGS. 5 and 6 is substantially the same as that of the circuits in FIGS. 1 and 2, and the inventors expect other circuits may be designed to fulfill the requirements of the invention. Similar to the circuit in FIG. 1, the circuit in FIG. 5 comprises a Wheatstone Bridge-Sensor Section (comprised of sensor element, R1 and threshold setting resistor VR1), a voltage comparator. A heater filament for heating the sensor substrate to a substantially constant level, and a power source, diode D1, and 5 volt regulator section are included at the left of FIG. 5. In FIG. 6 the Delay Timer (which may be a “555” industrial standard timer) is triggered by the circuitry in FIG. 5, and the switch and transmitter section at the right of FIG. 6 in turn are triggered for transmission of the alarm.

The inventors' expect that other circuits may be formulated for operative and efficient embodiments of the invention. In addition to the features shown in FIGS. 1, 2, 5 and 6, additional features may be added, such as discussed above for additional data gathering or fine-tuning of the system. Further, circuitry may be included in the local unit and/or the remote unit that indicates to the authority viewing the remote unit that the local unit has been disabled, for example, by breakage, wire-cutting, or other intentional or unintentional damage or disconnection.

The term “ppm” is understood to mean parts per million by volume, “ppb” is understood to mean parts per billion by volume, and “ppt” is understood to mean parts per thousand by volume. These terms based on volume are conventional units of measurement for gas concentrations.

Although this invention has been described above with reference to particular means, materials and embodiments, it is to be understood that the invention is not limited to these disclosed particulars, but extends instead to all equivalents within the scope of the following claims.

I claim:

1. A chemical detection system for monitoring illegal drug manufacture in a room, the detection system comprising:
a local unit installed in or near a room so that air from the room reaches the local unit, the local unit comprising a sensor for chemical gases associated with illegal drug manufacture and a transmitter system adapted to transmit an alarm signal to a remote location for alerting authorities to suspected illegal drug manufacture.

2. A detection system as in claim 1, wherein said chemical gases comprise volatile organic compounds.

3. A detection system as in claim 1, wherein said chemical gases comprise vaporized solvents.

4. A detection system as in claim 1, wherein said sensor senses chemical gases selected from the group consisting of: acetone, gasoline, anhydrous ammonia, cooking stove fuel, heating stove fuel, and mixtures thereof.

5. A detection system as in claim 1, further comprising a screened vent covering said local unit to let the air and chemical gases contained therein to reach the local unit and to hide the local unit from view inside the room.

6. A detection system as in claim 1, wherein said local unit comprises a threshold adjustor adjustable to trigger an alarm when the chemical gases reach a selected event detection threshold concentration.

7. A detection system as in claim 6, wherein said selected event detection threshold concentration is in the range of 100-900 ppm chemical gas in air.

8. A detection system as in claim 1, wherein said sensor comprises a sensor material on a substrate, and a heating system for heating the substrate to a predetermined substantially constant temperature so that the resistivity of the sensor material remains substantially constant until said chemical gas comes in contact with the sensor material and bonds to the sensor material to lowers the resistivity of said sensor material, and wherein said local unit comprises circuitry that responds to the lower resistivity and triggers an alarm when said lower resistivity reaches a level corresponding to a predetermined concentration of said chemical gas in the air.

9. A detection system as in claim 1, further comprising a remote unit positioned a distance from the local unit and adapted to receive said alarm signal from the local unit so that a person near the remote unit is informed of the presence of the chemical gas in the room indicating suspected illegal drug manufacture.

10. A detection system as in claim 9, comprising a wired communication system between said local unit and said remote unit.

11. A detection system as in claim 9, comprising a wireless communication system between said local unit and said remote unit.

12. A detection system as in claim 1, comprising no audible alarm system for sounding an audible alarm in the room.

13. A detection system as in claim 9, comprising no audible alarm system for sounding an audible alarm in the room.

14. A method of illegal drug manufacture in a room, the method comprising:
hiding a sensor in a room so that the sensor is exposed to the ambient air in the room and to any chemical gases from drug manufacture that are in the air, wherein the sensor is sensitive to a given concentration of said drug manufacture chemical gases in the air and signals an alarm in response to sensing such a concentration;
operatively connecting said sensor to a remote station a distance from the room so that the remote station receives the alarm so that an authority witnesses the alarm and becomes aware of the illegal drug manufacture.

15. The method of claim 14, wherein said sensor alarms when said chemical gases are in the air in a concentration of 100-900 ppm.
